(19) United States
(12) Patent Application Publication
(10) Pub. No.: US 2005/0076749 A1
(43) Pub. Date: Apr. 14, 2005

(54) Driving tool member having anti-slip device

(76) Inventor: Kuo Chen Liu, Taichung (TW)

Correspondence Address: Kuo Chen LIU, P.O. Box 63-99, Taichung, 406, TW

(21) Appl. No.: 10/684,302

(22) Filed: Oct. 10, 2003

(51) Int. Cl. B25B 15/00

(52) U.S. Cl. 81/436

(57) ABSTRACT

A driving tool member includes a driving shank having one or more blades each having one or more engaging surfaces, for engaging into and for driving driven members. For example, the driving shank may include a conventional flat blade or head, or a Phillips head, or a driving member having four engaging surfaces. The driving shank includes a number of projections extended outwardly from the engaging surfaces of the blades, to form a number of recesses between the projections, and to form a serrated anti-slip structure, to solidly engage with the driven members, and to prevent the driving shank from slipping relative to the driven members.

### BACKGROUND OF THE INVENTION

1. Field of the Invention

The present invention relates to a driving tool member, and more particularly to a driving tool member having an anti-slip device for preventing the driving tool member from slipping relative to the driven members.

2. Description of the Prior Art

Typical driving tool members, such as tool shanks of wrenches, tool extensions, tool bits of screw drivers, etc., comprise one or more blades provided on one end for engaging into and for driving driven members, such as fasteners, bolts, screws, etc.

For example, U.S. Pat. No. 1,780,785 to Jansson et al., U.S. Pat. No. 2,010,616 to Walsh, U.S. Pat. No. 4,212,336 to Smith, and U.S. Pat. No. 5,367,926 to Mikic et al. disclose several typical screw drivers having a flat or conventional driving blade for engaging into and for driving fasteners, bolts, screws, etc.

U.S. Pat. No. 2,522,217 to Fischer et al. discloses another typical screw driver having a Phillips head driving member for engaging into and for driving fasteners, bolts, screws, etc. U.S. Pat. No. 4,212,336 to Smith further discloses a typical driving shank of wrenches.

In these typical driving shanks or tool bits of the driving members, the driving ends or the driving blades of the driving members all include a flat structure having no anti-slip devices provided or formed therein, such that the driving tool member may easily slip relative to the driven members, and may thus be easily disengaged from the driven members.

The present invention has arisen to mitigate and/or obviate the afore-described disadvantages of the conventional driving tool members.

### SUMMARY OF THE INVENTION

The primary objective of the present invention is to provide a driving tool member including an anti-slip device for preventing the driving tool member from slipping relative to the driven members.

In accordance with one aspect of the invention, there is provided a driving tool member comprising a driving shank including one or more blades provided thereon, and each defined by one or more engaging surfaces, for engaging into and for driving driven members. The driving shank includes a plurality of projections extended outwardly from the engaging surfaces of the blades, to form a plurality of recesses between the projections, and for solidly engaging with the driven members, and for preventing the driving shank from slipping relative to the driven members.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a driving tool member in accordance with the present invention, in a shape of a screw driver bit having a Phillips head;

FIG. 2 is a perspective view of another driving tool member in a shape of a screw driver bit having a conventional flat type head; and

FIG. 3 is a perspective view of a further driving tool member in a shape of a driving shank of wrenches.

### DETAILED DESCRIPTION OF THE PREFERRED EMBODIMENT

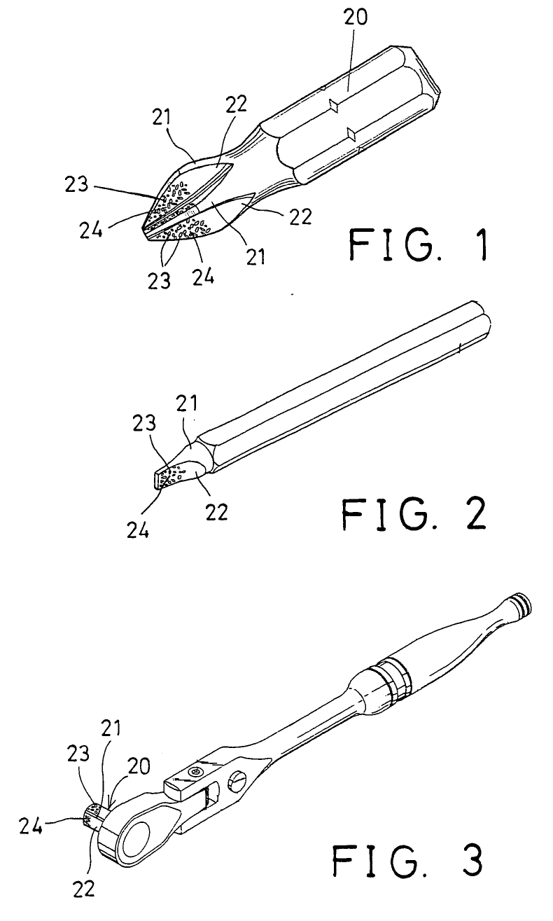

Referring to the drawings, and initially to FIG. 1, a driving tool member in accordance with the present invention comprises a driving shank 20 including one or more blades 21 formed or provided on one end thereof, and defined by two or more engaging surfaces 22, for engaging into and for driving driven members (not shown), such as fasteners, bolts, screws, etc.

For example, as shown in FIG. 1, the driving shank 20 includes four blades 21 formed or provided on one end thereof to form a Phillips head screw driver bit. As shown in FIG. 2, the driving shank 20 includes a single driving blade 21 formed or provided on one end thereof to form a conventional flat head screw driver bit. As shown in FIG. 3, the driving shank 20 includes a single driving blade 21 having four engaging surfaces 22 formed or provided thereon for engaging with the driven members.

The driving shank 20 includes a number of particles or projections 23 extended outwardly from one or more of the engaging surfaces 22 of the blades 21 respectively, in order to form or define a number of recesses 24 between the particles or projections 23, or to form a serrated surface or structure for the engaging surfaces 22 of the blades 21. The particles or projections 23 and the recesses 24 of the driving shank 20 may be formed in or on the driving shank 20 while molding or mold injecting the driving shank 20, or by forging or hammering processes, etc.

In operation, when the blades 21 of the driving shank 20 are engaged into the driven members, the particles or projections 23 of the driving shank 20 may be solidly engaged into or engaged with the driven members, to prevent the driving tool member from slipping relative to the driven members, and thus to prevent the driving tool member from being disengaged from the driven members while driving or rotating the driven members.

Accordingly, the driving tool member in accordance with the present invention includes an anti-slip device for preventing the driving tool member from slipping relative to the driven members.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A driving tool member comprising:
a driving shank including at least one blade provided thereon, and defined by at least one engaging surface, for engaging into and for driving driven members, and
said driving shank including a plurality of projections extended outwardly from said at least one engaging surface of said at least one blade, and formed on said at least one engaging surface of said at least one blade with a forging process, to form a plurality of recesses between said projections, and for solidly engaging with the driven members, and for preventing said driving shank from slipping relative to the driven members.

2. (canceled).
